(19) United States
(12) Patent Application Publication
(10) Pub. No.: US 2005/0088730 A1
(43) Pub. Date: Apr. 28, 2005

(54) Polarized light exposure apparatus for photo-alignment and adjustment method of polarization direction therein

(75) Inventors: Akifumi Sangu, Tokyo (JP); Osamu Osawa, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 10/971,143

(22) Filed: Oct. 25, 2004

(30) Foreign Application Priority Data
Oct. 24, 2003 (JP) 2003-364062

(51) Int. Cl. G11B 7/00; G02B 1/00

(52) U.S. Cl. 359/362

(57) ABSTRACT

In a polarized light exposure apparatus, light including ultraviolet rays emitted from a lamp 1a is condensed by an elliptic condensing mirror, is made parallel by a lens 5 whose position in an optical axis direction is adjustable by a lens moving mechanism, and enters a polarizing element 6. The light incident to the polarizing element 6 is separated and enters the integrator 7 for making irradiance distributions uniform, so that the light is irradiated on a work piece placed on the light irradiation area. Since the position in the optical axis direction is adjustable, the parallelism (Telecen Degree) to the optical axis of principal rays which are incident to the polarizing element 6 or the integrator 7, can be changed. Thus, it is possible to adjust the position of the lens 5 so as to uniform the polarization direction.

### FIELD OF THE INVENTION

The present invention relates to relates to an adjustment method of a polarization direction in a polarized light exposure apparatus and a polarized light exposure apparatus for performing a photo-alignment treatment by irradiating polarized light onto an alignment layer of a liquid crystal display element, or a wide-view film attached to a liquid crystal panel, and more especially, to an adjustment method of a polarization direction uniformity in a polarized light exposure apparatus for photo-alignment and a polarized light exposure apparatus, capable of uniforming polarization direction of the polarized light in a light irradiation area.

### DESCRIPTION OF THE RELATED ART

In order to prepare a liquid crystal display element, an alignment (or orientation) processing in which the orientation of liquid crystal is aligned in a desired direction is carried out to an alignment layer formed on a surface of a transparent substrate, and the respective alignment layers of two transparent substrates produced by the process are made to be faced to each other, the two transparent substrates are made to sandwich liquid crystal, and they are stuck together.

There is technology called photo-alignment in which in alignment processing of the alignment layer of the above-mentioned liquid crystal display element, the alignment is carried out by irradiating the polarized light having a predetermined wavelength to the alignment layer in order to perform exposure processing.

Such a polarized light exposure apparatus for photo-alignment is disclosed in for example, Japanese Patent Nos. 2928226, or 2960392.

Recently, in addition to manufacture of the above-mentioned liquid crystal display element, the above-mentioned polarized light exposure apparatus has also been used for manufacture of a wide-view film which is stuck on the surface of a liquid crystal panel so that deterioration of the image quality is compensated. Such a wide-view film is prepared by applying ultraviolet curing liquid crystal to a base film and making liquid crystal molecules align (or oriented) in a fixed direction, and then irradiating ultraviolet rays to the liquid crystal on the base film so as to cure the liquid crystal and fix the orientation of the crystal liquid molecules. Hereafter, a film, including a wide-view film, which produces photo-alignment is referred to as a photo-alignment film.

FIG. 5 is a schematic side elevational view of a conventional polarized light exposure apparatus for photo-alignment.

In FIG. 5, a light source 1 (for example, a 5 kW super high pressure mercury lamp) comprises a lamp 1a and an ellipse condensing mirror 1b. Light containing ultraviolet rays emitted from the lamp 1a is condensed by the ellipse condensing mirror 1b, reflected on a first plane mirror 2, passes through a filter 4 which light having wavelength passes through (transmits) selectively, made into parallel light by an input lens 5 (hereinafter referred to as merely a lens 5), and then inputted into a polarizing element 6. In the polarizing element 6, two or more glass plates are arranged so that Brewster angle is provided with respect to an optical axis. The lens 5 provided on the incident side of the polarizing element 6 is formed so that the principal rays (main light rays) of the light are parallel to the optical axis and thereby, the parallel light enters the polarizing element 6. The reason that the light which is incident to the polarizing element 6 is made into parallel light, is that the extinction ratio of the polarized light which comes out of the polarizing element 6 is deteriorated if the angle of the light which is incident to the polarizing element 6 shifts from the Brewster angle.

The principal rays mean that an optical path lines which come out of the center of the light source and go into arbitrary points of a light irradiation area.

The parallel light means that optical path lines that go into respective arbitrary points of the light irradiation area are parallel to each other on the incident side of the light irradiation area.

In addition, FIG. 5 shows only the principal rays which is incident to the center of the light irradiation area and is in agreement with the optical axis and two principal rays which are incident to both ends of the light irradiation area, for illustrative purposes.

Polarization separation of the light which is incident to the polarizing element 6 is carried out, and only P polarized light comes out of the above-mentioned polarizing element. The P polarized light is incident to an integrator lens 7 (which is also called a fly-eye lens but hereinafter referred to as an integrator 7), in which a group of light incident side lenses 7a and a group of light output side lenses 7b are disposed apart from each other. The integrator 7 is an optical element which makes irradiance distribution uniform in the light irradiation area. More than 10 to tens of lenses are arranged in parallel vertically and horizontally, and these lenses carry out separation (division) of incident light. The separated (divided) lights are overlaid in the light irradiation area. That is, if the distribution is symmetrical to the optical axis even though the irradiance distribution of light which is incident to the integrator 7 is uneven and the intensity of lights which are incident to the respective lenses differ, the irradiance distribution becomes uniform when irradiation of the lights emitted therefrom is overlaid in the same area.

In the example shown in FIG. 5, the group of light incident side lenses and the group of light output side lenses are disposed apart from each other. An integrator having such a structure is disclosed in Japanese Laid Open Patent No. 58-50510.

The P polarized light emitted from the integrator 7 enters the second plane mirror 20 through a shutter for controlling light irradiation in the light irradiation area 22.

The light reflected on the second plane mirror 20 is irradiated through the collimator 21 for making, into parallel light, the light to be irradiated in the light irradiation area 22, onto a work piece W, such as a substrate, a wide-view film, etc. which is placed in the light irradiation area 22 and to which a photo-alignment film has been applied. In addition, the collimator 21 is unnecessary when light irradiated to the work piece W does not have to be made into parallel light.

By the way, in order to carry out the photo-alignment of the photo-alignment film, polarized light having predetermined wavelength (for example, ultraviolet rays of 280-320 nm), and an extinction ratio which is a predetermined value or more (for example, the rate of contained S polarized light to P polarized light is 1/10-1/100) is required.

This is determined by the physical properties of the above-mentioned photo-alignment film. An extinction ratio means a rate of P polarization component and S polarization component contained in light.

For recent years, as a parameter for performing a photo-alignment, in addition to the wavelength and extinction ratio, uniformity in the direction of the polarized light within a light irradiation area (hereinafter referred to as a polarization direction) has come to be considered. This is because the contrast of the liquid crystal display element (screen of a liquid crystal panel) which is a product will change with places, when a photo-alignment is performed with light with the large variation within a field of a polarization axis.

For example, if the polarized light exposure apparatus of the above-mentioned conventional example is used, the uniformity within the field of the polarization direction in a light irradiation area will become about ±0.5 degrees.

However, there is also a user who requires that the uniformity within the field of a polarization direction be ±0.1 degrees or less, and thus the further improvement is called for recently.

### SUMMARY OF THE INVENTION

As a cause of the uniformity of a polarization direction in a light irradiation area, the aberration of a lens arranged in an optical path can be considered. For example, the lens 5 shown in FIG. 5 produces parallel light from light which is incident to the polarizing element 6. However, the light does not actually become perfect parallel light due to spherical aberration in practice. The parallelism of the emitting light is more largely deteriorated toward the circumference portion of the lens 5. On the other hand, the glass plate which comprises the polarizing element 6 is aslant arranged thereby forming the Brewster angle to an optical axis. Therefore, as shown in FIG. 6, when a component of the light which is not parallel light which comes out of the circumference portion of the lens 5, enters the polarizing element 6, the angle of the incident light on the side portion B near the lens and that of the incident light on the side portion C far from the lens become asymmetry (∠B≠∠C). Thus, the polarization direction of the polarized light outputted from the polarizing element 6 rotates, thereby leading to the uniformity of the polarization direction uniformity in the light irradiation area.

Moreover, when a component of the light which is not parallel light, comes out of the polarization element 6 and enters the integrator 7, rotation of a polarization direction arises similarly thereby leading to the uniformity of the polarization direction in the light irradiation area.

In addition, if the angle of the light which comes out of the polarization element, or the angle at which the polarized light is incident to the integrator 7 is asymmetrical, a polarization direction will rotate. This is because when spherical-surface form lenses are used for lenses which forms an integrator 7, the incident angle of the light which is incident to the four corners of each lens, with respect to the incident angle of the light which is incident to the center of each lens changes in X and Y directions along the curved surface of lenses, wherein the X and Y directions represent directions of two (2) axes running at right angle on a plane face vertical to the incident light. The relationship that an angle formed by a face formed by the direction of the normal of the light incident face and a light incident direction, and a polarization direction of the incident light is zero (0) or ninety degrees, is lost so that the polarization direction of the incident light is divided to two components running at right angle to each other, and the polarization axis direction rotates. Refer to Japanese Patent Application No. 2003-141665 for details. The spherical aberration of a lens is generally known well, and therefore taking into consideration the spherical aberration of the lens shown in FIG. 5, it is possible to design it so that the polarization direction in the light irradiation area uniforms. However, when the polarized light exposure apparatus designed in such a way is assembled, the value of the uniformity of the polarization direction in the light irradiation area is rather worse than a designed value, so that the uniformity of the polarization direction cannot be made to the desired value or less.

In view of the above problems, it is an object of the present invention to uniform a polarization direction in a light irradiation area in a polarized light exposure apparatus for performing a photo-alignment treatment.

The object of the present invention is accomplished by a polarized light exposure apparatus for photo-alignment, comprising a light source, a lens for making principal rays from the light source parallel, a polarizing element, an integrator, disposed in a light output side of the polarizing element, for making irradiance distribution uniform i a light irradiation area, and a holding unit for holding the lens, in which the lens is adjustably held in an optical axis direction. Accordingly, by moving the position of the above-mentioned lens in a direction of an optical axis with respect to the above-mentioned light source, the angle of the principal ray which is incident to the integrator is adjusted, thereby adjusting the uniformity of the polarization direction in the light irradiation area. In particular, a holding unit which movably holds the position of the above-mentioned lens in the direction of the optical axis is provided thereby adjusting the above-mentioned lens position to the light source so that the uniformity of the polarization direction of polarized light in the light irradiation area can be adjusted.

The holding unit may comprise a lens holding frame and a lens moving mechanism.

The lens holding frame may be movably carried on a lens stand.

The polarized light exposure apparatus may include a handle disposed in an upper portion of the lens holding frame.

The lens moving mechanism may comprise a guide member, and a projection section projected from the guide member, a fixing member adjustably holding the projection section, wherein the position of lens is adjusted by adjusting the fixing member.

Further, the object of the present invention is accomplished by an adjustment method of a polarization direction uniformity of a polarized light exposure apparatus for photo-alignment, in which principal rays of light which is incident to a lens is made parallel to an optical axis, and the light that comes out of the lens is irradiated in a light irradiation area through a polarizing element and an integrator for making irradiance distribution uniform in the light irradiation area, wherein a position of the lens to a light source is adjusted in an optical axis direction, so as to uniform of a polarization direction of polarized light in the light irradiation area.

Furthermore, the object of the present invention is achieved by an adjustment method of a polarization direction uniformity, comprising the following steps of changing a distance between a light source and a lens, finding an optimal position of the light source or the lens at which approximately best uniformity is acquired, and positioning the light source or the lens at the optimal position.

The optima position may be fined based on area size of a light irradiation area.

The adjustment method may further include a step of measuring a polarization direction, wherein the optimal position is fined based on a result of measuring the polarization direction.

The following effects can be acquired in the present invention.

(1) In a polarized light exposure apparatus in which a lens for making principal rays parallel to the optical axis, a polarizing element, and an integrator are arranged in the order, from the light source, since the above-mentioned lens is movable in the direction of the optical axis, and the above-mentioned lens position to the light source can be adjusted, even though there are factors which are not predictable at the time of a design, such as processing accuracy of the lens and the luminance distribution of the light source, it is possible to uniform the polarization direction in the light irradiation area by adjusting the angle of the principal rays which are incident to the integrator.

(2) Although the position of the lens at which the polarization direction uniforms best changes according to the area to which the polarized light is irradiated, since the lens is movable, the optimal lens position according to the irradiation area of the polarized light can be set up by movement of the lens.

### BRIEF DESCRIPTION OF THE DRAWINGS

FIG. 1A is a top plan view of the polarized light exposure apparatus according to the present invention. FIG. 1B is a side elevational view thereof;

FIG. 2A is a front elevational view of a lens holding frame and the lens moving mechanism in the optical axis direction, showing a line IIB-IIB, an arrow IIC and a circled portion IID;

FIG. 2B is a cross sectional view thereof taken along the line IIB-IIB, in a direction shown by arrows;

FIG. 2C is a top plan view thereof viewing in the direction of the arrow IIC shown in FIG. 2A;

FIG. 2D is an enlarged view of the lens moving mechanism which is circled as IID in FIG. 2A;

FIG. 3A is a schematic view of an apparatus for examining the polarization direction uniformity;

FIG. 3B shows a measurement result;

FIG. 4 shows a measurement result about a plurality of light irradiation areas;

FIG. 5 is a side view of a polarized light exposure apparatus for photo-alignment; and

FIG. 6 is an explanatory diagram to explain about an angle of light incident to a glass plate forming a polarizing element.

### DESCRIPTION OF THE PREFERRED EMBODIMENTS

These inventors investigated the cause by which the uniformity of the polarization direction in a light irradiation area became worse than a design value, in the actually assembled polarized light exposure apparatus. Consequently, it turned out that the polarization direction ununiforms for the reasons set forth below.

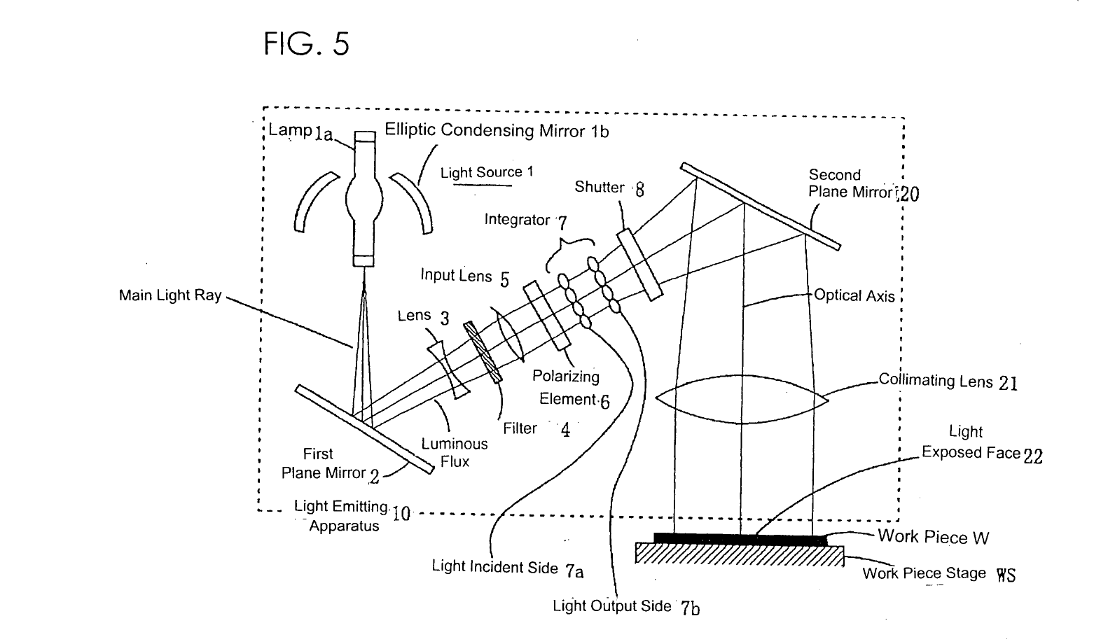

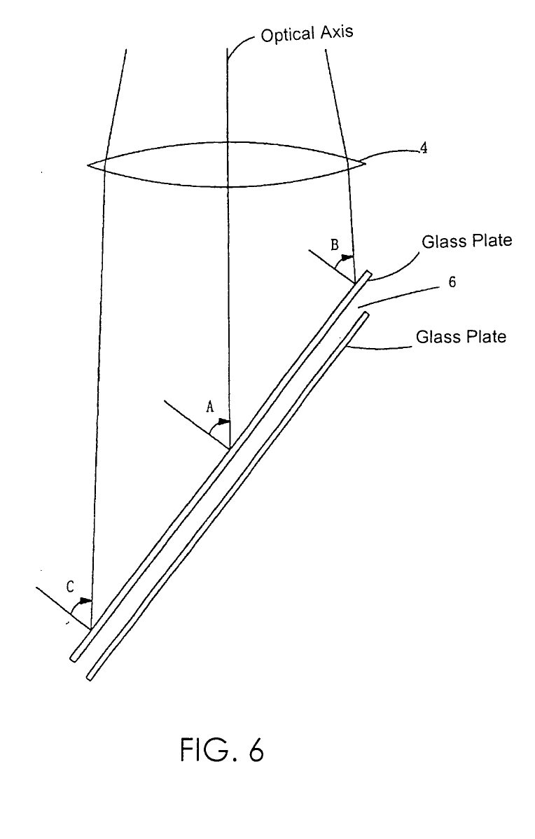

(a) In FIG. 5, according to the factors which cannot be predicted at the time of a design, such as the processing accuracy of each optical element containing the lens 5, distortion, individual difference or changes of the luminance distribution of a lamp 1a attached to an apparatus, the variation of the parallelism to the optical axis of a principal ray arises, so that the polarization direction in the light irradiation area ununiforms.

For example, the error is included in the surface treatment accuracy of the lens 5. Due to these errors, the parallelism (to be more exact, the parallelism of a principal ray to the optical axis) of the light which comes out of the lens, differs subtly to a design value (The parallelism may be called “Telecen Degree”). For this reason, the angle of the light which is incident to the polarization element 6 is different from a designed value, and the asymmetry of the angle of light which comes out of the polarization element 6 exists or the angle of the light which is incident to the integrator also differs, so that a polarization direction differs.

(b) If luminance distribution of the lamp 1a changes with time, the principal ray position of the optical axis which is incident to each optical element or incident angle changes so that the parallelism of rays which come out of the optical element changes. If the parallelism of the light changes, the light which is incident to the polarization element 6 or the integrator 7 becomes asymmetrical, and the polarization axis rotates so that the uniformity of the polarization direction in the light irradiation area occurs.

As a result of examinations, the inventors have reached to the conclusion that if the variation of the parallelism (Telecen degree) to the optical axis of the principal ray which is incident to the polarization element 6 or the integrator 7 can be changed, it is possible to compensate the gap to the designed value in the manufactured lens and change of the luminance distribution of the light source, so that the uniformity of the polarization direction in the light irradiation area can be adjusted so as to uniform it.

Here, in order to change the parallelism (Telecen Degree) to the optical axis of the principal ray which is incident to the polarization element 6 or the integrator 7, it is considered to be the simplest method, that the lens 5 provided on the incident side of the polarization element 6 is moved in a direction of the optical axis, so that distance to the light source is changed.

In view of the above consideration, the lens 5, provided on the incident side of the polarizing element, for forming principal rays to be parallel to the optical axis is movable along with the optical axis, and the angle of principal rays which are incident to the polarizing element 6 or the integrator 7 can be adjusted by adjusting the position of the lens in the optical direction to the light source. And the distance to the light source in the direction of an optical axis of the above-mentioned lens 5 was adjusted, and the variation of the polarization axis in a light exposed face was measured.

Consequently, as described later, there was a lens position where the uniformity of the polarization direction in a light irradiation area becomes the best, and it turned out that it is possible to make the uniformity of a polarization direction good by adjusting the position of a lens 5 to this position. It is viewed that the variation of the parallelism to the optical axis of the principal ray which is incidence to the integrator 7 is changed by adjusting the position of a lens 5, so that inclination of the polarization direction denies mutually at the integrator 7.

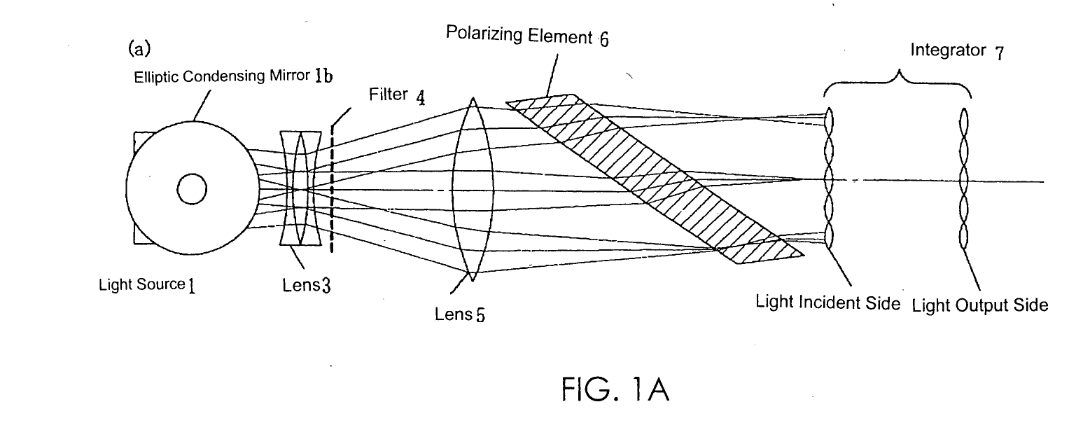

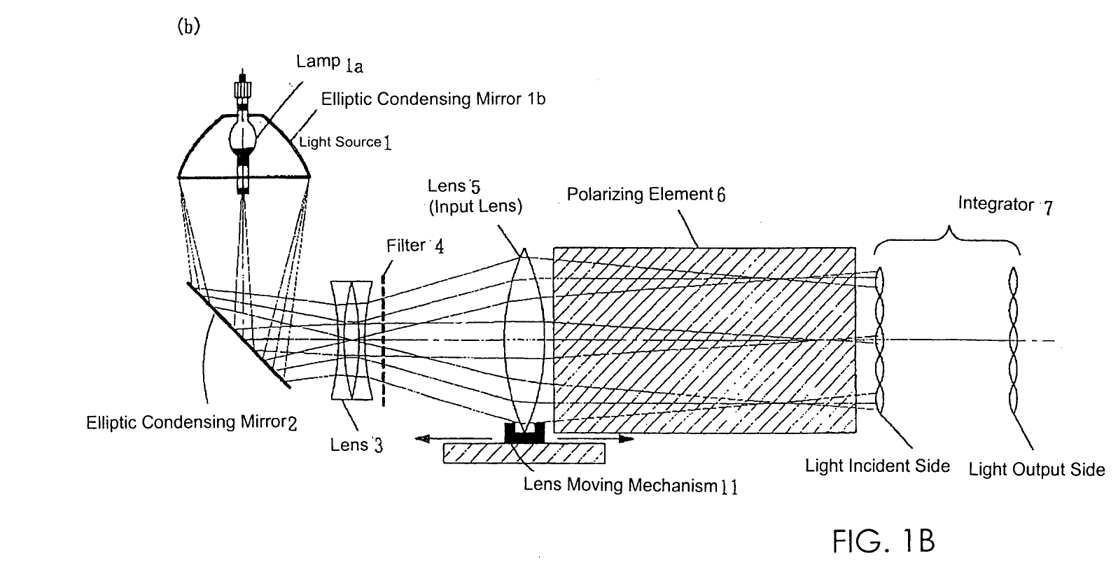

FIG. 1A is a top plan view of the polarized light exposure apparatus according to an embodiment of the present invention. FIG. 1B is a side elevational view thereof. FIG. 1B corresponds to FIG. 5.

This figure shows the structure of from the light source 1 to the integrator 7 in the polarized light exposure apparatus as shown in FIG. 5, and other structural elements are omitted.

As described above, the shutter, the second plane mirror, the collimator lens, etc. may be disposed on the light output side in FIG. 1, and polarized light emitted from the integrator 7 is irradiated on a work piece placed on the light irradiation area through the above-mentioned optical elements etc. In addition, the above-mentioned second plane mirror, a collimator lens, etc. are provided if needed.

In FIG. 1, light including ultraviolet rays which the lamp 1a emits is condensed by the ellipse condensing mirror 1b, reflected on the first plane mirror 2, is made into parallel light by the lens 5 through the lens 3 and the filter 4 which light with wavelength for carrying out a polarization treatment to a photo-alignment film selectively transmits, so as to enter the polarizing element 6. The lens moving mechanism 11 for moving the lens 5 in the direction of the optical axis is provided with the lens 5 disposed on the incident side of the polarizing element 6, and the distance between the light source 1 and the lens 5 can be adjusted by the lens moving mechanism 11. Light which is incident to the polarizing element 6 in which, as described above, for example, two or more glass plates incline by the Brewster angle with respect to the optical axis, is separated with polarization. The polarized light P which comes out of the polarizing element 6 enters the integrator lens 7 in which a group of light incident side lenses 7a provided on the light incident side and a group of light output side lenses 7b provided on the light output side are arranged apart from each other, thereby uniforming the irradiance distribution. The polarized light which comes out of the integrator 7 is irradiated on a work piece placed on the light irradiation area, which is a substrate to which a photo-alignment film is applied or a wide-view film, etc.

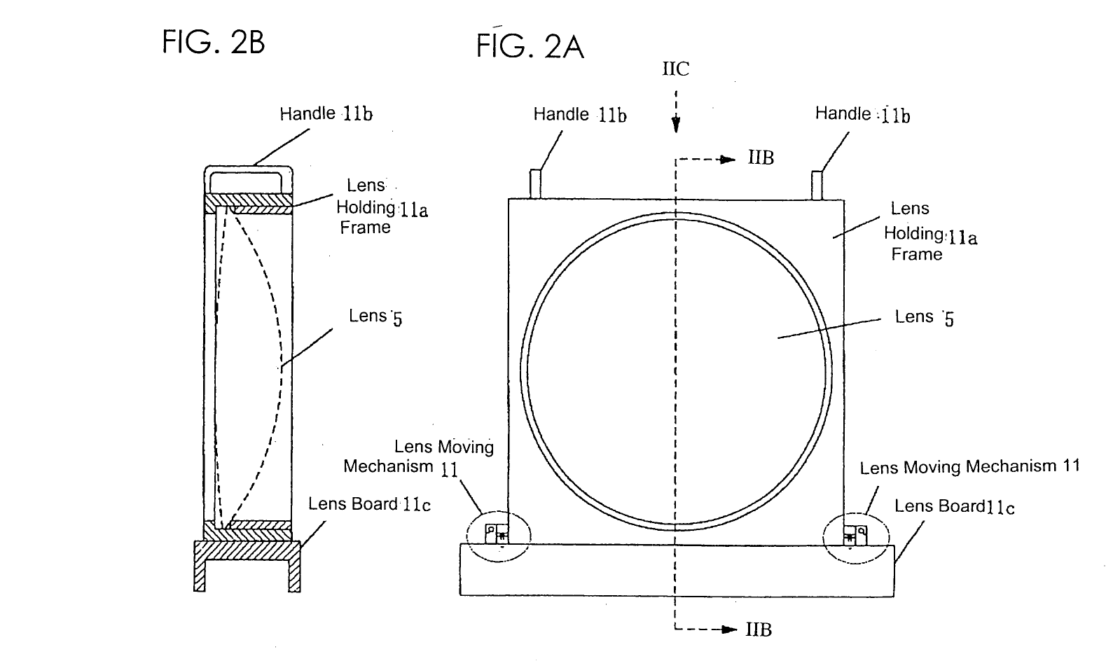

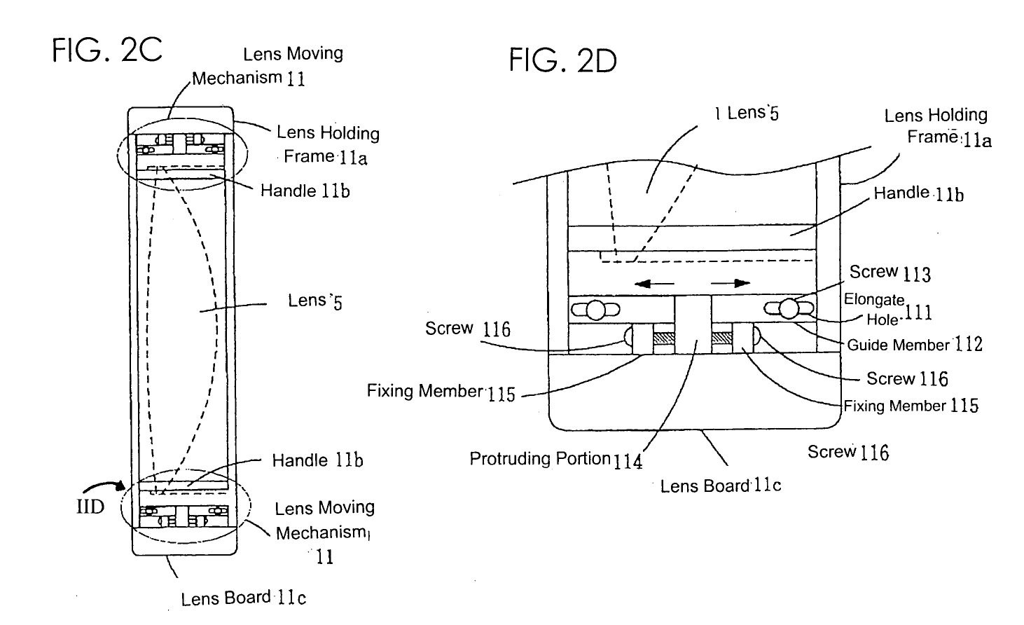

FIGS. 2A, 2B, 2C, and 2D show an example of the structure of the lens moving mechanism 11 in which the above-mentioned lens 5 is moved in the direction of an optical axis.

FIG. 2A is a front elevational view of a lens holding frame and the lens moving mechanism in the optical axis direction, showing a line IIB-IIB, an arrow IIC and a circled portion IID. FIG. 2B is a cross sectional view thereof taken along the line IIB-IIB, in a direction shown by arrows. FIG. 2C is a top plan view thereof viewing in the direction of the arrow IIC shown in FIG. 2A. FIG. 2D is an enlarged view of the lens moving mechanism which is circled as IID in FIG. 2A.

As shown in this figure, the lens 5 is held by a lens holding frame 11a, the lens holding frame 11a is movably carried on a lens stand 11c, and a handle 11b is attached to the upper portion of the lens holding frame 11a.

As shown in FIGS. 2C and 2D, a guide member 112 having elongate holes 111 is provided to each side of the lens holding frame 11a, a screw 113 attached to the lens stand 11c is penetrated in each elongate hole 111.

For this reason, the lens holding frame 11a is movable in the direction of the optical axis of the lens 5 along with the elongate holes 111.

Furthermore, a projection section 114 is formed in each side of the lens holding frame 11a, and fixing members 115 are formed in the lens stand 11c, and a screw 116 is attached in a screw hole formed in each fixing member 115. The above-mentioned fixing members 115 are formed in both sides of the above-mentioned projection section 114, and the above-mentioned screws 116 are in contact with the projection section 114 from both sides of the projection section 114. In order to adjust the position of the lens 5 in the direction of the optical axis, one of the screws 116, which are attached in the fixing member 115 is loosened and the other screw 116 is screwed up. Accordingly, the lens holding frame 11a, that is, lens 5 moves slightly in the direction of the optical axis.

In addition, the lens moving mechanism is not necessarily limited to the above-mentioned structure, and as long as the lens 5 can be moved in the direction of the optical axis, any other various structures may be used for the present invention.

In order to verify the effect of the present invention, the lens 5 was moved in the direction of the optical axis, and change of the variation of the polarization axis was examined.

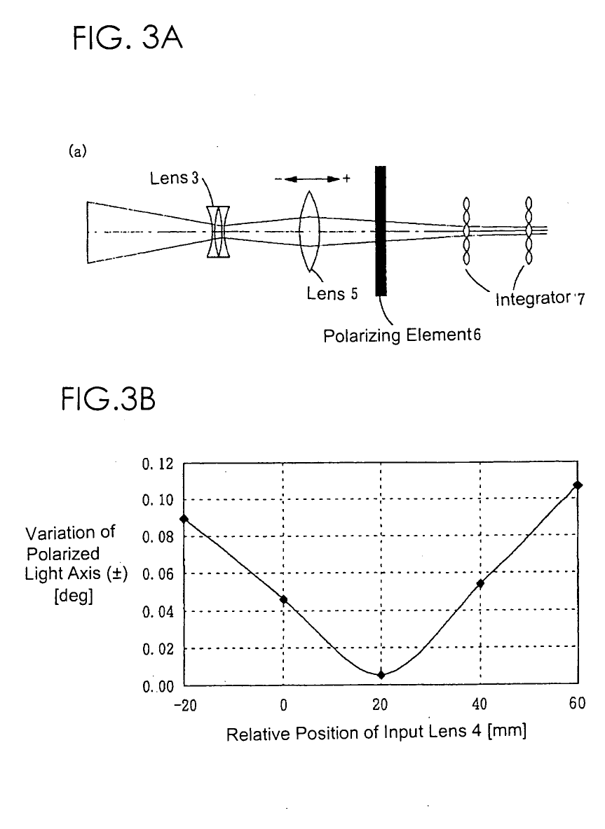

In order to examine the variation of polarization direction uniformity in the light exposed face, as shown in FIG. 3A, the lens 5 was provided in the light incident side of the polarizing element 6, the integrator 7 was disposed in the light output side of the polarizing element 6, wherein polarized light emitted from the integrator 7 was irradiated onto the light exposed face (not shown) and while the lens 5 was moved in the optical axis direction, the uniformity of the polarization direction were measured.

The measurement result is shown in FIG. 3B.

In the figure, a horizontal axis represents the relative position (mm) of the lens 5 in the direction of the optical axis, a vertical axis represents the uniformity of the polarization axis (polarization direction uniformity: ±deg), and the position 0 mm of the horizontal axis is a designed position.

In this case, the uniformity of the polarization direction in the range of 920 mm×920 mm was investigated.

As shown in FIG. 3B, the uniformity of the polarization direction in case that the lens 5 is in the designed position (0 mm position) is ±0.46 degrees.

On the other hand, if the lens 5 is made to approach the polarizing element 6, gradually, the uniformity of the polarization axis became good and became best at approximately 20 mm distance from the designed value (±0.005 degrees). If it is made to approach furthermore, the uniformity became bad again. That is, it was shown that the uniformity of the polarization in a light irradiation area can be adjusted by moving the lens 5 in the direction of the optical axis. In practice, at a stage of adjusting the optical property of polarized light exposure apparatus, while the position of a lens 5 is changed, the uniformity of the polarization direction in a light irradiation area is measured, and the lens 5 is fixed in the position where the uniformity became the best.

Moreover, for a user who is using an apparatus, the uniformity of the polarization direction is measured periodically, when the measured result is out of the desired range of set predetermined value, the lens moving mechanism is moved thereby moving the lens 5 so that the uniformity of the polarization direction is adjusted.

This operation may be carried out automatically, if a CPU connected to a unit for measuring uniformity of polarization direction, the lens moving mechanism, a light source controlling unit. The CPC has a memory to store necessary data and programs to carry out the operation.

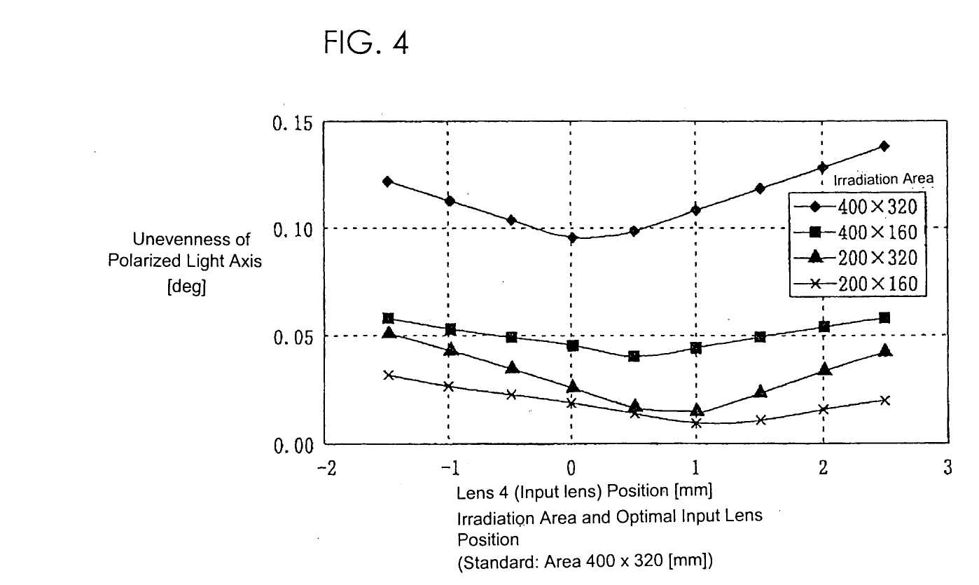

FIG. 4 shows change of the uniformity of the polarization direction about two or more light irradiation areas when the lens 5 was moved in the optical axis direction.

In this figure, a horizontal axis represents the position (mm) of the lens 5 and a vertical axis represents the uniformity of the polarization direction (polarization direction uniformity: ±deg) in the light irradiation area.

In this case, the relationship between the position of the lens 5 in the optical axis direction and the uniformity of the polarization direction in four light irradiation areas where the polarized light was irradiated and whose dimensions are 400 mm×320 mm 400 mm×160 mm 200 mm×320 mm and 200 mm×160 mm, was examined. If the optimal position of the lens 5 was O when an light exposed area was 400 mm×320 mm, the optimal position of the lens 5 in case of the light irradiation area 400 mm×160 mm was a position moved in a direction toward the integrator 7 by an approximately about 0.5 mm distance. Similarly, the optimal position of the lens 5 is a position moved in a direction toward the integrator 7 by an approximately 0.8 mm distance in case of the light exposed area 200 mm×320 mm, and by an approximately 1.0 mm distance in case of the light exposed area 200 mm×160 mm.

Thus, when the size of the area to be irradiated by the polarized light differs, the position of the lens 5 also differs in order to make the best uniformity of the polarization direction.

However, even when the size of an alignment film is changed so that the size of the area to be irradiated by the polarized light is changed, it is possible to uniform the polarization direction by moving the lens 5 by the lens moving mechanism.

Thus the present invention possesses a number of advantages or purposes, and there is no requirement that every claim directed to that invention be limited to encompass all of them.

The disclosure of Japanese Patent Application No. 2003-364026 filed on Oct. 24, 2003 and Japanese Patent Application No. 2003-141665, including specification, drawings and claims thereof is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A polarized light exposure apparatus for photo-alignment, comprising:
a light source;
a lens for making principal rays from the light source parallel;
a polarizing element;
an integrator, disposed in a light output side of the polarizing element, for making irradiance distribution uniform in a light irradiation area; and
a holding unit for holding the lens, in which the lens is adjustably held in an optical axis direction.

2. The polarized light exposure apparatus according to claim 1, wherein the holding unit comprises a lens holding frame and a lens moving mechanism.

3. The polarized light exposure apparatus according to claim 2, wherein the lens holding frame is movably carried on a lens stand.

4. The polarized light exposure apparatus according to claim 2, further including a handle disposed in an upper portion of the lens holding frame.

5. The polarized light exposure apparatus according to claim 2, wherein the lens moving mechanism comprises a guide member, and a projection section projected from the guide member, a fixing member adjustably holding the projection section, wherein the position of lens is adjusted by adjusting the fixing member.

6. An adjustment method of a polarization direction uniformity of a polarized light exposure apparatus for photo-alignment, in which principal rays of light which is incident to a lens is made parallel to an optical axis, and the light that comes out of the lens is irradiated in a light irradiation area through a polarizing element and an integrator for making irradiance distribution uniform in the light irradiation area, wherein a position of the lens to a light source is adjusted in an optical axis direction, so as to uniform a polarization direction of polarized light on the light irradiation areas.

7. An adjustment method of a polarization direction uniformity, comprising the following steps of:
changing a distance between a light source and a lens;
finding an optimal position of the light source or the lens at which approximately best uniformity is acquired; and
positioning the light source or the lens at the optimal position.

8. The adjustment method according to claim 7, further including, measuring uniformity of a polarization direction, wherein the optimal position is fined based on a result of measuring the uniformity.

9. The adjustment method according to claim 7, wherein the optima position is fined based on area size of a light irradiation area to be irradiated.
